(19) United States
(12) Patent Application Publication
(10) Pub. No.: US 2026/0252858 A1
(43) Pub. Date: Aug. 27, 2026

(54) SYNTHETIC DATA GENERATION FOR AI USE CASES

(71) Applicant: SAP SE, Walldorf (DE)

(72) Inventors: Ziyuan Shang, Singapore (SG); Alexy Xena Hackmann, Singapore (SG); Zhen Shu, Singapore (SG); Junxiang Jia, Singapore (SG); Wen Yang Tan, Singapore (SG)

(21) Appl. No.: 19/065,165

(22) Filed: Feb. 27, 2025

(51) Int. Cl. G06N 3/0475

(52) U.S. Cl. CPC G06N 3/0475

(57) ABSTRACT

Generative AI (GenAI) applications make use of a prompt to guide the output of the Large Language Model (LLM). The prompt is generally composed of a static template with placeholders for input data, which are populated when the LLM is invoked. A solution is presented herein for generating synthetic data directly from the use case prompt template, reducing the dependency on actual data collection processes across a wide range of task domains. In some example embodiments, two main steps are performed. First, the LLM is asked to generate personas. Using the personas, the LLM is asked to generate input data for the placeholders of a prompt template. The responses for multiple personas are aggregated and de-duplicated, resulting in a synthetic set of values for the placeholder of the prompt template.

### TECHNICAL FIELD

The subject matter disclosed herein generally relates to synthetic data generation for artificial intelligence (AI) use cases. Specifically, the present disclosure addresses systems and methods to automate data generation, collection, and evaluation for generative AI applications.

### BACKGROUND

Machine Learning (ML) is an application that provides computer systems the ability to perform tasks, without explicitly being programmed, by making inferences based on patterns found in the analysis of data. ML explores the study and construction of algorithms, also referred to herein as models, that may learn from existing data and make predictions about new data.

A Large Language Model (LLM) is a type of ML model that uses natural language to receive input and generate responses. LLMs process input using transformer architectures that enable parallel processing of data elements and attention mechanisms for detecting relationships between elements regardless of their distance in the input sequence. The input to an LLM is referred to as a prompt.

The process of prompt engineering involves creating prompts that reliably generate desired outputs from an LLM. To simplify prompt engineering, a generative AI (GenAI) application uses a prompt template in combination with input data. Since the prompt engineer does not know the specific input data at template creation time, comprehensive testing of the template with diverse input data is essential for ensuring reliable operation.

Testing prompt templates requires substantial computing resources, including processor cycles, memory usage, and network bandwidth. However, obtaining representative test data is technically challenging due to data format constraints, verification requirements, and the need to maintain consistent data structures across testing iterations. These technical limitations restrict the ability to thoroughly validate prompt template performance and optimize LLM response generation.

The technical challenges of prompt template testing are compounded by the complex architecture of modern LLMs, which utilize multiple neural network layers, attention mechanisms, and transformer-based processing to generate responses. Effective testing must account for how different input data patterns interact with these architectural elements while maintaining structural consistency of the test data.

### BRIEF DESCRIPTION OF THE DRAWINGS

Some embodiments are illustrated by way of example and not limitation in the figures of the accompanying drawings.

FIG. 1 is a network diagram illustrating a network environment suitable for synthetic data generation for AI use cases, according to some example embodiments.

FIG. 2 is a block diagram of a data generation server, according to some example embodiments, suitable for synthetic data generation for AI use cases.

FIG. 3 illustrates the structure of a neural network, according to some example embodiments.

FIGS. 4-5 are block diagrams of a database schema suitable for use in synthetic data generation for AI use cases, according to some example embodiments.

FIG. 6 is a block diagram of a user interface suitable for use in synthetic data generation for AI use cases, according to some example embodiments.

FIG. 7 is a flowchart illustrating operations of a method suitable for synthetic data generation for AI use cases, according to some example embodiments.

FIG. 8 is a flowchart illustrating operations of a method suitable for using synthetic data to test a GenAI application, according to some example embodiments.

FIG. 9 is a block diagram showing one example of a software architecture for a computing device.

FIG. 10 is a block diagram of a machine in the example form of a computer system within which instructions may be executed for causing the machine to perform any one or more of the methodologies discussed herein.

### DETAILED DESCRIPTION

Example methods and systems are directed to synthetic data generation for AI use cases. GenAI applications hold significant value for various business use cases. These applications make use of a prompt to guide the output of the Large Language Model (LLM). Crafting and testing the prompts used in GenAI applications is a time-consuming process. A prompt is generally composed of a static template with placeholders for input data, which are populated when the LLM inference is invoked.

To ensure effective prompt engineering, developers of GenAI applications need to test and evaluate the responses of different prompt templates using diverse input data. However, it can be difficult to obtain representative input data. Authentic customer data is scarce and challenging to acquire due to stringent data protection regulations and privacy concerns. This scarcity and lack of diversity in genuine data restricts the ability of GenAI developers to comprehensively test, evaluate, and optimize the prompt templates. Insufficient testing could lead to suboptimal performance of the application in production environments.

A solution is presented herein for generating synthetic data directly from the use case prompt template, reducing the dependency on actual data collection processes across a wide range of task domains. In some example embodiments, two main steps are performed. First, the LLM is asked to generate personas. Each persona includes one or more characteristics of a person that might use the GenAI application. For example, personas for a GenAI tool for job searching could be defined by an area of expertise (e.g., lawyer or software developer). As another example, personas for a GenAI tool for clothing design could be defined by age and gender (e.g., old man or young woman).

After personas are generated, the LLM is asked to generate input data for the placeholders of a prompt template. For example, the LLM may be asked to fill in a name of a company to which a persona is applying for a job. As a result, the LLM will identify businesses and law firms to which a lawyer may apply for a lawyer persona, and businesses and software companies to which a software developer may apply for a software developer persona.

The responses for multiple personas are aggregated and de-duplicated, resulting in a synthetic set of values for the placeholder of the prompt template. This set of values may be used with the prompt template to form a set of prompts for a GenAI application. The correctness of the responses from the GenAI application can be checked and, if appropriate, the prompt template revised.

In various example embodiments, the present disclosure addresses the need for large volumes of reliable data in today's data-driven environments. It offers a scalable solution that minimizes the dependency on actual data collection, saving time and resources while ensuring data generation validity and quality. This capability makes it suitable for integration into the pipeline of developing GenAI solution as well as training machine learning models.

Thus, the functioning of the resulting GenAI application is improved as compared to GenAI applications developed without the additional synthetic data generated using the systems and methods disclosed herein. When these effects are considered in aggregate, one or more of the methodologies described herein may obviate a need for certain efforts or resources that otherwise would be involved in generating testing data, developing a GenAI application, or using a GenAI application. Computing resources used by one or more machines, databases, or networks may similarly be reduced. Examples of such computing resources include processor cycles, network traffic, memory usage, data storage capacity, power consumption, and cooling capacity.

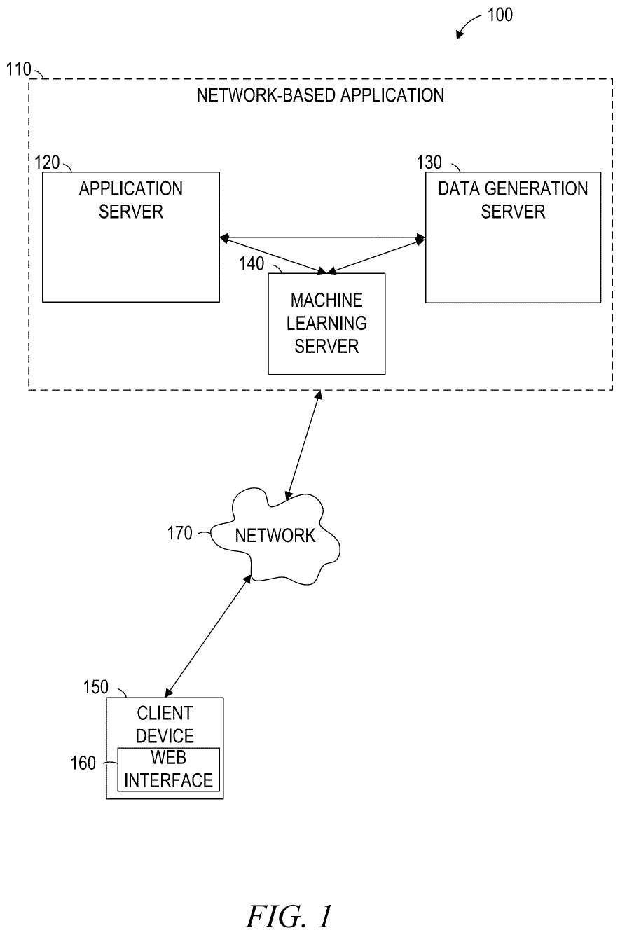

FIG. 1 is a network diagram illustrating a network environment 100 suitable for synthetic data generation for AI use cases, according to some example embodiments. The network environment 100 includes a network-based application 110, a client device 150, and a network 170. The network-based application 110 is provided by an application server 120 in communication with a machine learning server 140 and a data generation server 130.

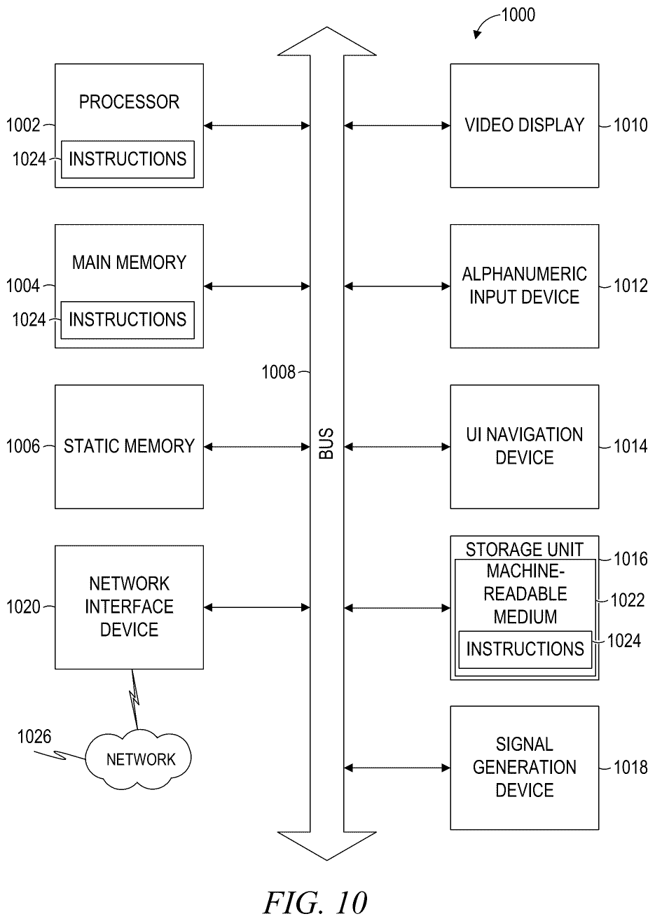

The application server 120 provides an application to the client device 150 via a web interface 160. The application server 120, the data generation server 130, the machine learning server 140, and the client device 150 may each be implemented in a computer system, in whole or in part, as described below with respect to FIG. 10.

The application server 120 receives a request from the client device 150 for a web interface. In response to the request, the application server 120 sends a web page (e.g., one or more files comprising hypertext markup language (HTML), cascading style sheets (CSS), JavaScript, or any suitable combination thereof) via the network 170 to the client device 150. The web interface 160 (e.g., a web browser running on the client device 150) generates the user interface for presentation on a display device of the client device 150 based on the data received from the application server. The user interface comprises a set of user interface elements (e.g., input controls, images, text, or embedded video).

The application may be a GenAI application. The user provides, via the user interface, values for one or more placeholders in an otherwise predefined prompt. The prompt, as modified by the user input, is provided to a GenAI of the machine learning server 140. A response from the GenAI is presented in the user interface.

The data generation server 130 generates synthetic values for the placeholders to facilitate testing of the GenAI application. The application server 120 or the machine learning server 140 sends a request to the data generation server 130 for the synthetic data. The request may identify one or more prompts for which the synthetic data is to be generated.

The data generation server 130 generates one or more personas to be used in generating the synthetic data. Taking the role of a persona, the data generation server 130 generates a set of synthetic data values that the persona would be likely to use in the prompt. The synthetic data is provided to the application server 120 or the machine learning server 140 for use in testing a GenAI application.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the data generation server 130, the ML server 140, and the client device 150 are connected by the network 170. The network 170 may be any network that enables communication between or among machines, databases, and devices. Accordingly, the network 170 may be a wired network, a wireless network (e.g., a mobile or cellular network), or any suitable combination thereof. The network 170 may include one or more portions that constitute a private network, a public network (e.g., the Internet), or any suitable combination thereof.

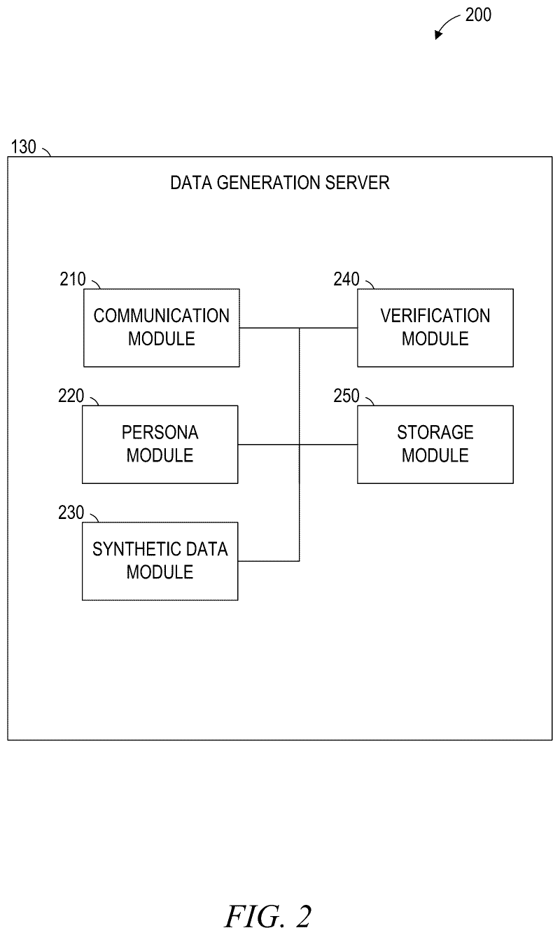

FIG. 2 is a block diagram 200 of the data generation server 130, according to some example embodiments, suitable for synthetic data generation for AI use cases. The data generation server 130 is shown as including a communication module 210, a persona module 220, a synthetic data module 230, a verification module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the data generation server 130 and transmits data from the data generation server 130. For example, the communication module 210 receives, from the machine learning server 140, a request for synthetic data; receives, from the application server 120, prompts that include placeholders for the synthetic data; sends, to the machine learning server 140, the prompts including the synthetic data; or any suitable combination thereof.

The persona module 220 generates personas for use in generating synthetic data. For example, a job search GenAI application may be used by people with different skill sets, ages, backgrounds, and so on. Different personas differ from each other by one or more characteristics. The synthetic data module 230 generates synthetic data while taking on the role of a particular persona. Based on the persona, different synthetic data is generated. For example, a lawyer persona may be interested in jobs with different employers than a software engineer persona.

The verification module 240 verifies the synthetic data generated by the synthetic data module 230. In some example embodiments, the persona module 220, the synthetic data module 230, or both are implemented using GenAI. The GenAI is instructed to output the synthetic data in a structured format, such as JavaScript Object Notation (JSON). The verification module 240 verifies that the output conforms to the instructed format. Improperly formatted synthetic data may be discarded.

Prompts, personas, synthetic data, source code, executable instructions, and the like may be stored by the storage module 250. The storage may be internal to the data generation server 130 (e.g., a hard drive or solid-state drive) or external (e.g., accessed from a network storage device or database server).

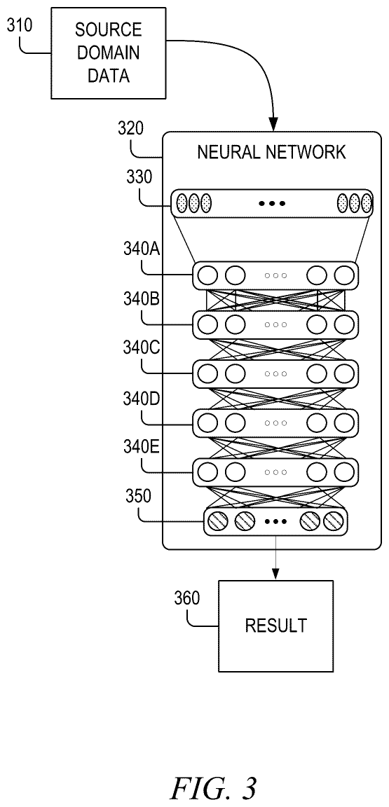

FIG. 3 illustrates the structure of a neural network 320, according to some example embodiments. The neural network 320 takes source domain data 310 as input, processes the source domain data 310 using the input layer 330; the intermediate, hidden layers 340A, 340B, 340C, 340D, and 340E; and the output layer 350 to generate a result 360.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output, and are completely internal to the neural network 320. Though five hidden layers are shown in FIG. 3, more or fewer hidden layers may be used.

A model may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the model is evaluated and the values of its variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network, a recurrent neural network, or another type of neural network. A neuron is an architectural element used in data processing and artificial intelligence, particularly machine learning which includes memory that may determine when to “remember” and when to “forget” values held in that memory based on the weights of inputs provided to the given neuron. An example type of neuron in the neural network 320 is a Long Short Term Memory (LSTM) node. Each of the neurons used herein are configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance are related to one another.

For example, an LSTM serving as a neuron includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a pre-determined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

The transformer architecture processes an entire input at once rather than sequentially. For example, a RNN processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating AI, and the like) being provided as an input for determination of the next result.

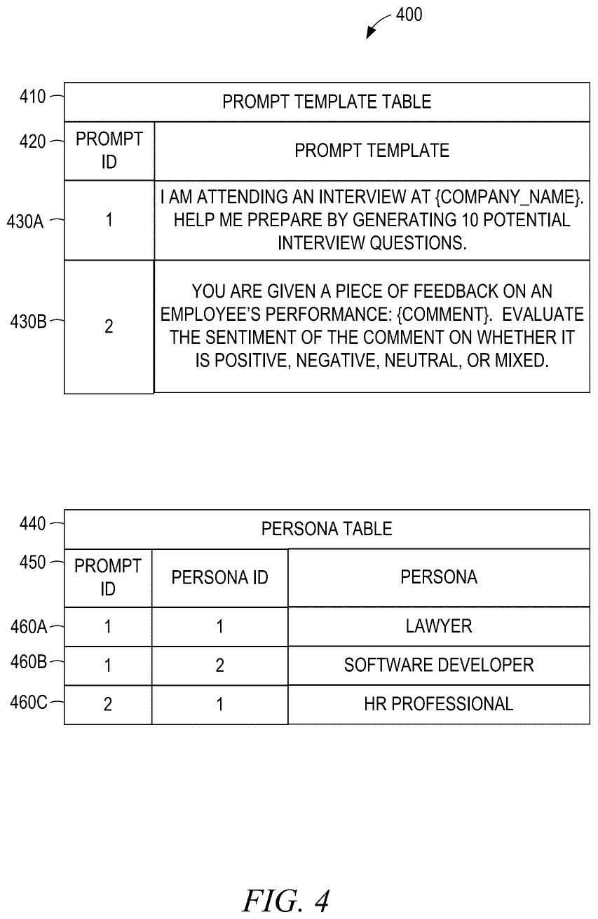

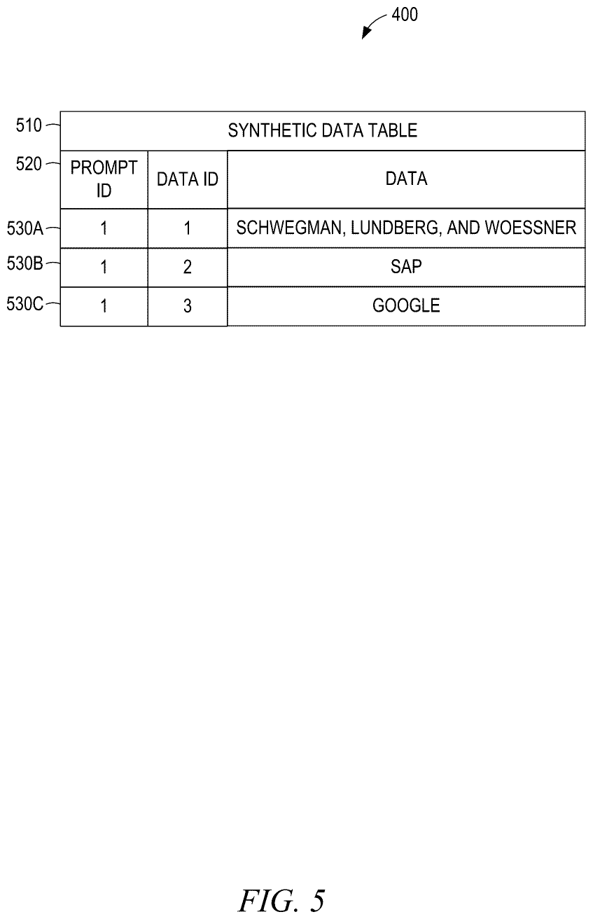

FIGS. 4-5 are block diagrams of a database schema 400 suitable for use in synthetic data generation for AI use cases, according to some example embodiments. The database schema 400 includes a prompt template table 410, a persona table 440, and a synthetic data table 510. As shown in FIG. 4, the prompt template table 410 includes rows 430A and 430B of a format 420. The persona table 440 includes rows 460A, 460B, and 460C of a format 450. By way of example, the prompt template table 410, the persona table 440, and the synthetic data table 510 each contain only a few rows. In practice, the prompt template table 410 may contain one or more rows for each GenAI application, the persona table 440 may contain several or dozens of rows for each GenAI application, and the synthetic data table 510 may contain hundreds or thousands of rows for each GenAI application.

The data generation server 130 stores prompts for GenAI applications in the prompt template table 410. The format 420 of the prompt template table 410 includes a prompt identifier field and a prompt template field. The first prompt template, in the row 430A, includes a placeholder for a company name. The second prompt template, in the row 430B, includes a placeholder for a comment on an employee's performance.

A GenAI application using the first prompt template could include a web page into which a prospective job seeker could enter the name of a company to which they are applying for a job. In response, the GenAI application would provide a list of interview questions. For testing purposes, it would be helpful to have a set of synthetically generated company names, so that the output of the GenAI application could be checked.

The second prompt template could be used by a GenAI application for generating overall ratings of employees. Comments on employee performance may be accessed from a database. Each comment may be rated, using the second prompt, as being either positive, negative, neutral, or mixed. Action may be taken based on whichever rating is in the majority.

The data generation server 130 stores personas for generating synthetic data in the persona table 440. As indicated by the format 450, each of the rows 460A-460C includes a prompt identifier field, a persona identifier field, and a persona field. The persona field may include a category or short description of the persona. In the example of FIG. 4, the persona fields of the rows 460A-460C include professions of people that may generate values for the placeholders in the prompts of the prompt template table 410.

For the first prompt template, two personas are stored in the persona table 440: a lawyer persona and a software developer persona. These personas may generate different values for the company name placeholder in the first prompt template. For example, the lawyer persona may attend interviews at law firms and the software developer may attend interviews at software companies. Thus, different synthetic data may be generated using the different personas.

For the second prompt template, one persona is stored in the persona table 440, an HR professional persona. Other possible personas may include customer or manager. Each of these personas may generate values for the comment placeholder in the second prompt template.

As shown in FIG. 5, the synthetic data table 510 includes rows 530A, 530B, and 530C of a format 520. The format 520 shows that each of the rows 530A-530C includes a prompt identifier, a data identifier, and data. Thus, the three rows 530A-530C include values generated for the prompt of the row 430A and can be used to replace the placeholder for company name in that prompt.

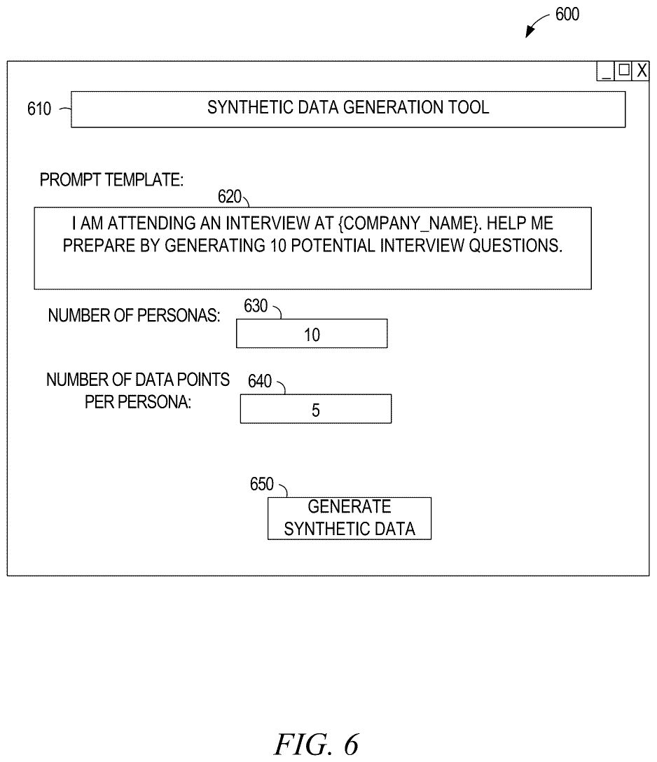

FIG. 6 is a block diagram of a user interface 600 suitable for use in synthetic data generation for AI use cases, according to some example embodiments. The user interface 600 may be generated by the application server 120 or the data generation server 130, and presented on a display of the client device 150 (e.g., using the web interface 160), all of FIG. 1. The user interface 600 includes a title 610, a prompt template field 620, a number of personas field 630, a number of data points per persona field 640, and a button 650.

The title 610 indicates that the user interface 600 is for a synthetic data generation tool. The prompt template field 620 receives text input from a user. In this example, the text is:
I am attending an interview at {company_name}. Help me prepare by generating 10 potential interview questions.

The number of personas field 630 receives text or numeric input from a user. In this example, the number is 10. The number of data points per persona field 640 also receives a value from a user. In this example, the value is 5. The button 650 is operable to cause the data generation server 130 to generate synthetic data for the prompt template provided in the prompt template field 620.

Based on the value of the number of personas field 630, the data generation server 130 will generate ten different personas for people that would use a GenAI application that uses the prompt template provided in the prompt template field 620. After the personas are generated, the data generation server 130 generates, based on the value of the number of data points per persona field 640, five data points for each persona. Thus, fifty synthetic data points will be generated by the data generation server 130 in response to submission of the data shown in FIG. 6, via the button 650.

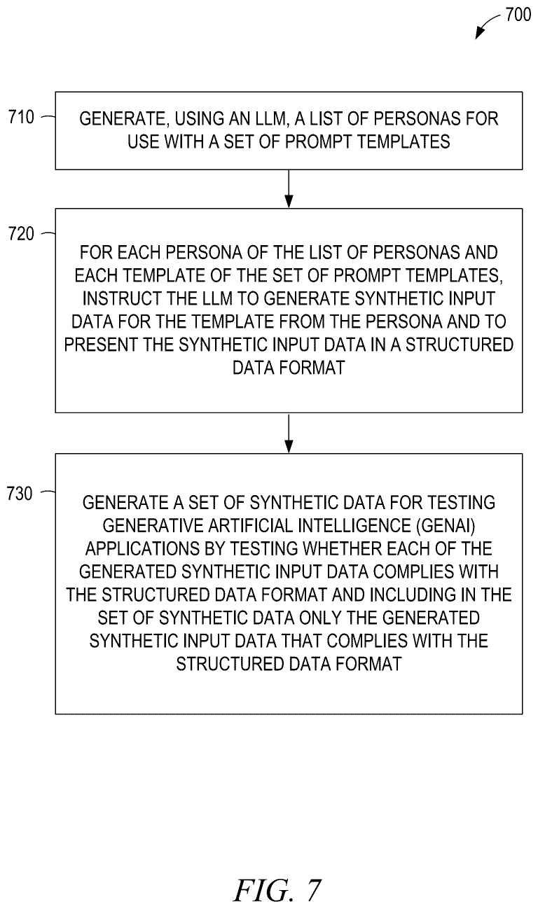

FIG. 7 is a flowchart illustrating operations of a method 700 suitable for synthetic data generation for AI use cases, according to some example embodiments. The method 700 includes operations 710, 720, and 730. By way of example and not limitation, the method 700 is described as being performed in the network environment 100 of FIG. 1 by the data generation server 130 described in FIG. 2 using the database schema 400 of FIGS. 4-5.

In operation 710, the persona module 220 of the data generation server 130 generates, using an LLM, a list of personas for use with a set of prompt templates. For example, a GenAI developer using the client device 150 may submit a request, via the user interface 600 of FIG. 6, to the data generation server 130 to generate a number of personas specified in the request (e.g., ten) for one or more prompt templates. Example prompt templates are shown in the prompt template table 410 of FIG. 4.

A prompt may be provided to an LLM for each prompt template to generate the personas for the template. An example prompt is shown below, where <prompt template> is replaced by the prompt template for the GenAI application, and <number> is replaced by the number of personas the LLM is to generate.
You have the following prompt template: “<prompt template>” Words enclosed in curly braces { } represent variables. Provide a list of <number> personas that are likely to use this prompt template.

Thus, in this example embodiment, the prompt for generating ten personas for the prompt template of the row 430A is
You have the following prompt template: “I am attending an interview at {company_name}. Help me prepare by generating 10 potential interview questions.” Words enclosed in curly braces { } represent variables. Provide a list of ten personas that are likely to use this prompt template.

The generated personas may be stored in the persona table 440. In operation 720, the synthetic data module 230 instructs the LLM to generate synthetic input data for each persona of the list of personas and each template of the set of prompt templates. Additionally, the LLM is instructed to present the synthetic input data in a structured format, such as a JSON data structure. The instructions to the LLM may identify a number of data values to be generated. An example prompt is shown below, where <prompt template> is replaced by the prompt template for which synthetic data is being requested, <persona> is replaced by one of the personas generated in operation 710, <number> is replaced by the number of data values to be generated, and <format> is replaced by a structured data format for the output.
You have the following prompt template: “<prompt template>” Words enclosed in curly braces { } represent variables.
Put yourself into the character of a <persona>.
Generate <number> data points for data to be substituted into the variables of the prompt template. Each data point is to be presented in <format>.

An example prompt, with the <prompt template>, <persona>, <number>, and <format> placeholders replaced with values is:
You have the following prompt template: “I am attending an interview at {company_name}. Help me prepare by generating 10 potential interview questions.” Words enclosed in curly braces { } represent variables.
Put yourself into the character of a lawyer.
Generate five data points for data to be substituted into the variables of the prompt template. Each data point is to be presented in JSON, using the following structure:

```
{
  “type”: “object”,
  “properties”: {
    “{variable name}”: “generated data point”
    }
}
```

The instructing of the LLM to generate synthetic data may include instructing the LLM to generate metadata with the synthetic input data. Metadata generation may be useful for data generation workflows where a relationship exists between datapoints. For example, the gender of the user may be relevant. Accordingly, the additional instructions below may be included:
Generate data in pairs. Each pair should contain one data point for a male user and one data point for a female user. Also include the index, which is a number tracking the pairs of data, and the gender, where the value is either “male” or “female.”

The instruction may also include one or more sample data points. An example additional instruction for this purpose is:
You may refer to these sample data points to guide your data generation: 1. DBS Bank 2. Singapore Airlines

In operation 730, the synthetic data module 230 generates a set of synthetic data for testing GenAI applications. The verification module 240 tests whether each of the generated synthetic input data complies with the structured data format. The synthetic data module 230 includes in the set of synthetic data only the generated synthetic input data that complies with the structured data format. Thus, malformed output from the LLM is discarded. For example, the testing whether each of the generated synthetic input data complies with the structured data format may include determining whether each of the generated synthetic input data is a valid JSON object. Structurally correct output from the LLM may be stored in the synthetic data table 510. Thus, by use of the method 700, synthetic data for testing GenAI applications may be efficiently generated and verified. As a result, the development and testing cycle for GenAI applications is improved.

When synthetic data is determined to be invalid, a prompt-based recovery mechanism may be employed. This mechanism incorporates the error message from the validation into a new prompt, allowing the LLM to correct itself. For example, if a property called “Name” is supposed to be present in a JSON object created by the LLM, but the property is missing, the verification module 240 may generate an error message such as “Name property missing in JSON object.” Accordingly, the LLM may receive a recovery prompt such as:
Your last output was invalid because “Name property missing in JSON object.” Please correct the formatting and provide the output again.

The second output from the LLM is provided to the verification module 240. If the second output is correct, it is used. Otherwise, both outputs are discarded.

In some example embodiments, the set of synthetic data generated in operation 730 is deduplicated before use. For example, multiple personas may have some overlap in the values generated. By removing duplicate values, the potential over-weighting of those values in testing a GenAI application is eliminated.

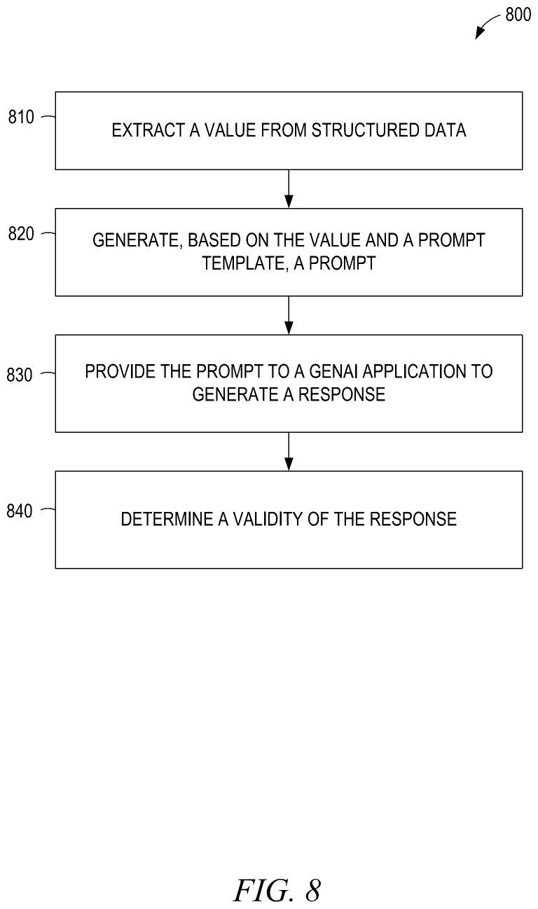

FIG. 8 is a flowchart illustrating operations of a method 800 suitable for using synthetic data to test a GenAI application, according to some example embodiments. The method 800 includes operations 810, 820, 830, and 840. By way of example and not limitation, the method 800 is described as being performed in the network environment 100 of FIG. 1 by the application server 120 and the machine learning server 140 using the database schema 400 of FIGS. 4-5. The method 800 may be performed using the synthetic data generated by the method 700 of FIG. 7.

In operation 810, the application server 120 extracts a value from structured data. For example, the set of synthetic data generated in operation 730 of the method 700 may include multiple data structures. Operation 810 thus applies to one of the structured data. An example JSON data structure corresponding to the synthetic data of the row 530B of FIG. 5 is:

```
{
  “type”: “object”,
  “properties”: {
    “company_name”: “SAP”
    }
}
```

The value extracted from the above data object is “SAP.” The application server 120, in operation 820, generates a prompt based on the value and a prompt template. The prompt may be generated by substituting the extracted value for the corresponding placeholder in the prompt template. Continuing with the example used in the description of FIG. 7 and the example structured data above, an example prompt is:
I am attending an interview at SAP. Help me prepare by generating 10 potential interview questions.

In operation 830, the application server 120 provides the prompt to an GenAI application to generate a response. For example, the response may be:
Tell me about yourself.
What are your salary expectations?
How do you deal with conflict?
What are your weaknesses?
What are your strengths?
Why should we hire you?
Why are you interested in this position?
Give an example of when you have used your leadership skills.
Tell me about a challenge you overcame in your previous role.
why did you leave your last job?

The application server 120, or a user of the application server 120, determines a validity of the response (operation 840). The method 800 may be repeated for each element of the set of synthetic data generated by the method 700. Thus, the synthetic data generated by the method 700 is used to test a GenAI application.

### EXAMPLES

Example 1 is a system comprising: one or more processors; and a memory that stores instructions that, when executed by the one or more processors, cause the one or more processors to perform operations comprising: generating, using a large language model (LLM), a list of personas for use with a set of prompt templates; for each persona of the list of personas and each template of the set of prompt templates, instructing the LLM to generate synthetic input data for the template from the persona and to present the synthetic input data in a structured data format; and generating a set of synthetic data for testing generative artificial intelligence (GenAI) applications by testing whether each of the generated synthetic input data complies with the structured data format and including in the set of synthetic data only the generated synthetic input data that complies with the structured data format.

In Example 2, the subject matter of Example 1, wherein the operations further comprise: testing a GenAI application using the generated set of synthetic data.

In Example 3, the subject matter of Examples 1-2, wherein the operations further comprise: receiving, via a user interface, a number of personas to generate; wherein the generating of the list of personas comprises providing a prompt to the LLM that identifies the number of personas to generate and the set of prompt templates.

In Example 4, the subject matter of Examples 1-3, wherein the operations further comprise: receiving, via a user interface, a number of data points to generate for each persona; wherein the instructing of the LLM to generate synthetic input data for the template from the persona comprises providing a prompt to the LLM that identifies the number of data points to generate for each persona.

In Example 5, the subject matter of Examples 1-4, wherein the structured data format is a Javascript Object Notation (JSON) format and the testing whether each of the generated synthetic input data complies with the structured data format comprises determining whether each of the generated synthetic input data is a valid JSON object.

In Example 6, the subject matter of Examples 1-5, wherein the generating of the synthetic data for testing GenAI applications further comprises removing duplicate generated synthetic input data.

In Example 7, the subject matter of Examples 1-6, wherein the instructing of the LLM to generate synthetic input data for the template from the persona includes instructing the LLM to generate metadata with the synthetic input data.

In Example 8, the subject matter of Example 7, wherein the metadata indicates a gender of a subject of the synthetic input data.

In Example 9, the subject matter of Examples 1-8, wherein the instructing of the LLM to generate synthetic input data for the template from the persona includes providing sample data points to the LLM.

Example 10 is a method comprising: generating, using a large language model (LLM), a list of personas for use with a set of prompt templates; for each persona of the list of personas and each template of the set of prompt templates, instructing the LLM to generate synthetic input data for the template from the persona and to present the synthetic input data in a structured data format; and generating a set of synthetic data for testing generative artificial intelligence (GenAI) applications by testing whether each of the generated synthetic input data complies with the structured data format and including in the set of synthetic data only the generated synthetic input data that complies with the structured data format.

In Example 11, the subject matter of Example 10 includes testing a GenAI application using the generated set of synthetic data.

In Example 12, the subject matter of Examples 10-11 includes receiving, via a user interface, a number of personas to generate; wherein the generating of the list of personas comprises providing a prompt to the LLM that identifies the number of personas to generate and the set of prompt templates.

In Example 13, the subject matter of Examples 10-12 includes receiving, via a user interface, a number of data points to generate for each persona; wherein the instructing of the LLM to generate synthetic input data for the template from the persona comprises providing a prompt to the LLM that identifies the number of data points to generate for each persona.

In Example 14, the subject matter of Examples 10-13, wherein the structured data format is a Javascript Object Notation (JSON) format and the testing whether each of the generated synthetic input data complies with the structured data format comprises determining whether each of the generated synthetic input data is a valid JSON object.

In Example 15, the subject matter of Examples 10-14, wherein the generating of the synthetic data for testing GenAI applications further comprises removing duplicate generated synthetic input data.

In Example 16, the subject matter of Examples 10-15, wherein the instructing of the LLM to generate synthetic input data for the template from the persona includes instructing the LLM to generate metadata with the synthetic input data.

In Example 17, the subject matter of Example 16, wherein the metadata indicates a gender of a subject of the synthetic input data.

Example 18 is a non-transitory machine-readable medium that stores instructions that, when executed by one or more processors, cause the one or more processors to perform operations comprising: generating, using a large language model (LLM), a list of personas for use with a set of prompt templates; for each persona of the list of personas and each template of the set of prompt templates, instructing the LLM to generate synthetic input data for the template from the persona and to present the synthetic input data in a structured data format; and generating a set of synthetic data for testing generative artificial intelligence (GenAI) applications by testing whether each of the generated synthetic input data complies with the structured data format and including in the set of synthetic data only the generated synthetic input data that complies with the structured data format.

In Example 19, the subject matter of Example 18, wherein the operations further comprise: testing a GenAI application using the generated set of synthetic data.

In Example 20, the subject matter of Examples 18-19, wherein the operations further comprise: receiving, via a user interface, a number of personas to generate; wherein the generating of the list of personas comprises providing a prompt to the LLM that identifies the number of personas to generate and the set of prompt templates.

Example 21 is at least one machine-readable medium including instructions that, when executed by processing circuitry, cause the processing circuitry to perform operations to implement of any of Examples 1-20.

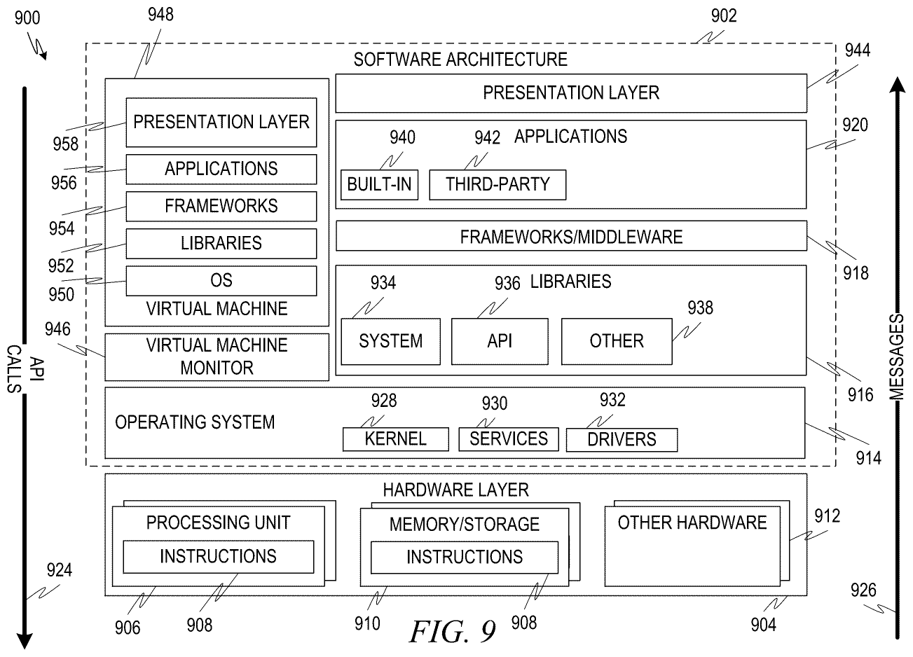

FIG. 9 is a block diagram 900 showing one example of a software architecture 902 for a computing device. The software architecture 902 may be used in conjunction with various hardware architectures, for example, as described herein. FIG. 9 is merely a non-limiting example of a software architecture and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the software architecture 902.

In the example architecture of FIG. 9, the software architecture 902 may be conceptualized as a stack of layers where each layer provides particular functionality. For example, the software architecture 902 may include layers such as an operating system 914, libraries 916, frameworks/middleware layer 918, applications 920 and presentation layer 944. Operationally, the applications 920 and/or other components within the layers may invoke application programming interface (API) calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware layer 918 may provide a higher-level common infrastructure that may be utilized by the applications 920 and/or other software components/modules. For example, the frameworks/middleware layer 918 may provide various graphic user interface (GUI) functions, high-level resource management, high-level location services, and so forth. The frameworks/middleware layer 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built in applications as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built-in operating system functions (e.g., kernel 928, services 930 and/or drivers 932), libraries (e.g., system libraries 934, API libraries 936, and other libraries 938), frameworks/middleware layer 918 to create user interfaces to interact with users of the system. Alternatively, or additionally, in some systems interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

FIG. 10 is a block diagram of a machine in the example form of a computer system 1000 within which instructions 1024 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube [CRT]). The computer system 1000 also includes an alphanumeric input device 1012 (e.g., a keyboard or a touch-sensitive display screen), a user interface (UI) navigation (or cursor control) device 1014 (e.g., a mouse), a disk drive unit 1016, a signal generation device 1018 (e.g., a speaker), and a network interface device 1020.

The disk drive unit 1016 includes machine-readable media 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media 1022.

While the machine-readable media 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks. A machine-readable medium is not a transmission medium.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system comprising:
one or more processors; and
a memory that stores instructions that, when executed by the one or more processors, cause the one or more processors to perform operations comprising:
generating, using a large language model (LLM), a list of personas for use with a set of prompt templates;
for each persona of the list of personas and each template of the set of prompt templates, instructing the LLM to generate synthetic input data for the template from the persona and to present the synthetic input data in a structured data format; and
generating a set of synthetic data for testing generative artificial intelligence (GenAI) applications by testing whether each of the generated synthetic input data complies with the structured data format and including in the set of synthetic data only the generated synthetic input data that complies with the structured data format.

2. The system of claim 1, wherein the operations further comprise:
testing a GenAI application using the generated set of synthetic data.

3. The system of claim 1, wherein the operations further comprise:
receiving, via a user interface, a number of personas to generate;
wherein the generating of the list of personas comprises providing a prompt to the LLM that identifies the number of personas to generate and the set of prompt templates.

4. The system of claim 1, wherein the operations further comprise:
receiving, via a user interface, a number of data points to generate for each persona;
wherein the instructing of the LLM to generate synthetic input data for the template from the persona comprises providing a prompt to the LLM that identifies the number of data points to generate for each persona.

5. The system of claim 1, wherein the structured data format is a Javascript Object Notation (JSON) format and the testing whether each of the generated synthetic input data complies with the structured data format comprises determining whether each of the generated synthetic input data is a valid JSON object.

6. The system of claim 1, wherein the generating of the synthetic data for testing GenAI applications further comprises removing duplicate generated synthetic input data.

7. The system of claim 1, wherein the instructing of the LLM to generate synthetic input data for the template from the persona includes instructing the LLM to generate metadata with the synthetic input data.

8. The system of claim 7, wherein the metadata indicates a gender of a subject of the synthetic input data.

9. The system of claim 1, wherein the instructing of the LLM to generate synthetic input data for the template from the persona includes providing sample data points to the LLM.

10. A method comprising:
generating, using a large language model (LLM), a list of personas for use with a set of prompt templates;
for each persona of the list of personas and each template of the set of prompt templates, instructing the LLM to generate synthetic input data for the template from the persona and to present the synthetic input data in a structured data format; and
generating a set of synthetic data for testing generative artificial intelligence (GenAI) applications by testing whether each of the generated synthetic input data complies with the structured data format and including in the set of synthetic data only the generated synthetic input data that complies with the structured data format.

11. The method of claim 10, further comprising:
testing a GenAI application using the generated set of synthetic data.

12. The method of claim 10, further comprising:
receiving, via a user interface, a number of personas to generate;
wherein the generating of the list of personas comprises providing a prompt to the LLM that identifies the number of personas to generate and the set of prompt templates.

13. The method of claim 10, further comprising:
receiving, via a user interface, a number of data points to generate for each persona;
wherein the instructing of the LLM to generate synthetic input data for the template from the persona comprises providing a prompt to the LLM that identifies the number of data points to generate for each persona.

14. The method of claim 10, wherein the structured data format is a Javascript Object Notation (JSON) format and the testing whether each of the generated synthetic input data complies with the structured data format comprises determining whether each of the generated synthetic input data is a valid JSON object.

15. The method of claim 10, wherein the generating of the synthetic data for testing GenAI applications further comprises removing duplicate generated synthetic input data.

16. The method of claim 10, wherein the instructing of the LLM to generate synthetic input data for the template from the persona includes instructing the LLM to generate metadata with the synthetic input data.

17. The method of claim 16, wherein the metadata indicates a gender of a subject of the synthetic input data.

18. A non-transitory machine-readable medium that stores instructions that, when executed by one or more processors, cause the one or more processors to perform operations comprising:
generating, using a large language model (LLM), a list of personas for use with a set of prompt templates;
for each persona of the list of personas and each template of the set of prompt templates, instructing the LLM to generate synthetic input data for the template from the persona and to present the synthetic input data in a structured data format; and
generating a set of synthetic data for testing generative artificial intelligence (GenAI) applications by testing whether each of the generated synthetic input data complies with the structured data format and including in the set of synthetic data only the generated synthetic input data that complies with the structured data format.

19. The non-transitory machine-readable medium of claim 18, wherein the operations further comprise:
testing a GenAI application using the generated set of synthetic data.

20. The non-transitory machine-readable medium of claim 18, wherein the operations further comprise:
receiving, via a user interface, a number of personas to generate;
wherein the generating of the list of personas comprises providing a prompt to the LLM that identifies the number of personas to generate and the set of prompt templates.
